(19) United States
(12) Patent Application Publication
(10) Pub. No.: US 2019/0274288 A1
(43) Pub. Date: Sep. 12, 2019

(54) Insect Feeding Assembly

(71) Applicant: Thomas Cargill, North Plainfield, NJ (US)

(72) Inventor: Thomas Cargill, North Plainfield, NJ (US)

(21) Appl. No.: 15/914,158

(22) Filed: Mar. 7, 2018

(51) Int. Cl. A01K 53/00

(52) U.S. Cl. CPC A01K 53/00

(57) ABSTRACT

A insect feeding assembly includes a pedestal that may be positioned on a support surface. A plurality of watering units is provided and each of the watering units is coupled to the pedestal. Each of the watering units may be mounted by an insect and each of the watering units contains water for drinking by the insect. A feeder is coupled to the pedestal and the feeder is selectively mounted by an insect. The feeder contains a fluid food thereby facilitating the insect to consume the fluid food. Additionally, the pedestal is positioned in a high traffic area with respect to the insects thereby facilitating the insects to rest on the feeder and the watering units during pollination.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to feeding devices and more particularly pertains to a new feeding device for providing a stopping point for pollinating animals.

### BRIEF SUMMARY OF THE INVENTION

An embodiment of the disclosure meets the needs presented above by generally comprising a pedestal that may be positioned on a support surface. A plurality of watering units is provided and each of the watering units is coupled to the pedestal. Each of the watering units may be mounted by an insect and each of the watering units contains water for drinking by the insect. A feeder is coupled to the pedestal and the feeder is selectively mounted by an insect. The feeder contains a fluid food thereby facilitating the insect to consume the fluid food. Additionally, the pedestal is positioned in a high traffic area with respect to the insects thereby facilitating the insects to rest on the feeder and the watering units during pollination.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of an insect feeding assembly according to an embodiment of the disclosure.

FIG. 2 is a bottom view of an embodiment of the disclosure.

FIG. 3 is a top view of an embodiment of the disclosure.

FIG. 4 is an exploded perspective view of a feeder of an embodiment of the disclosure.

FIG. 5 is a perspective in-use view of an embodiment of the disclosure.

FIG. 6 is a cross sectional view taken along line 6-6 of FIG. 1 of an embodiment of the disclosure.

FIG. 7 is a cross sectional view taken along line 7-7 of FIG. 3 of an embodiment of the disclosure.

### DETAILED DESCRIPTION OF THE INVENTION

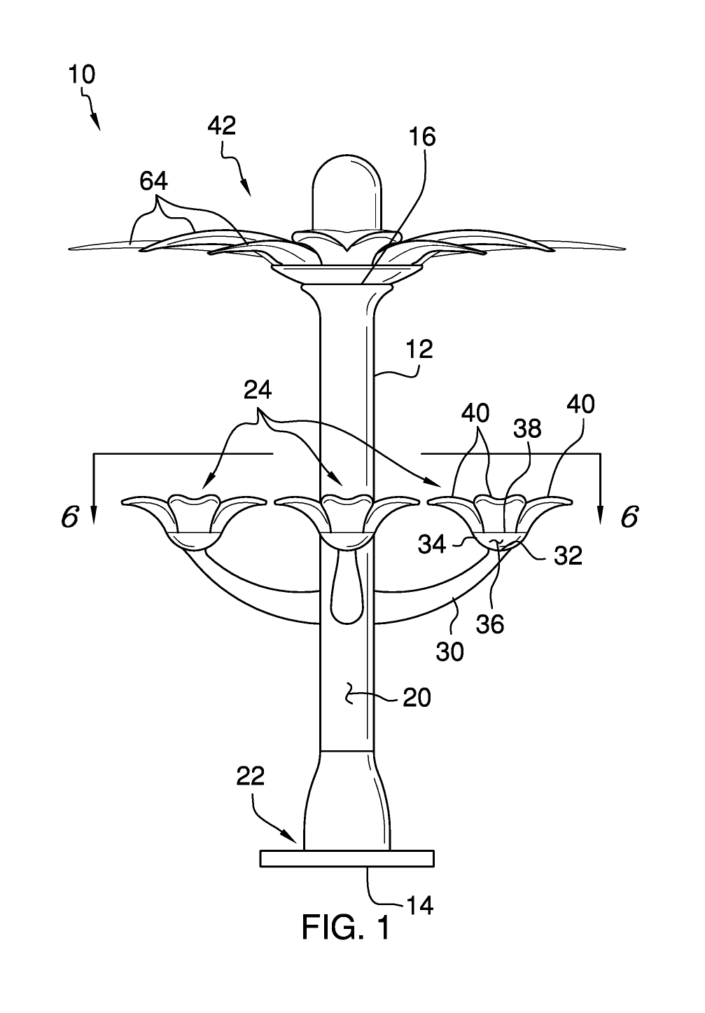

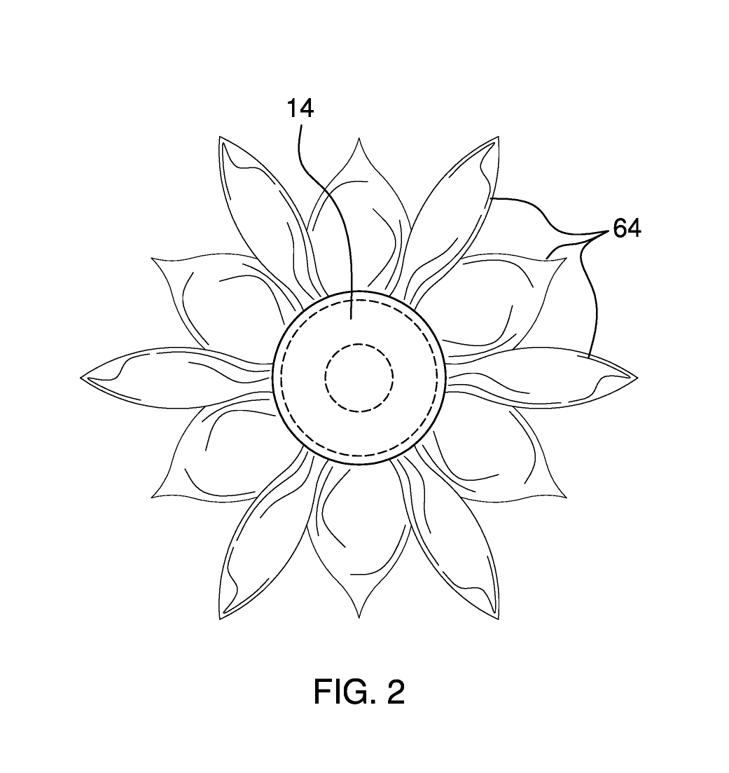

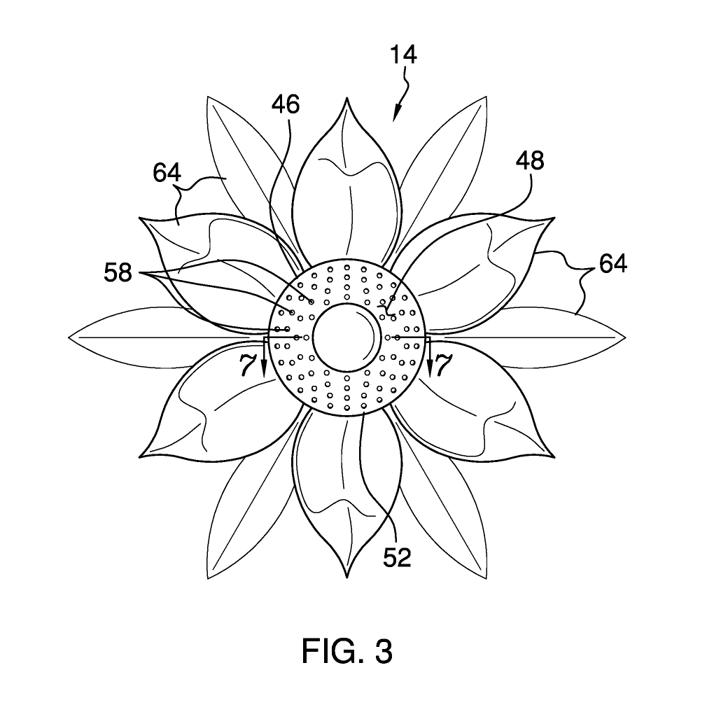

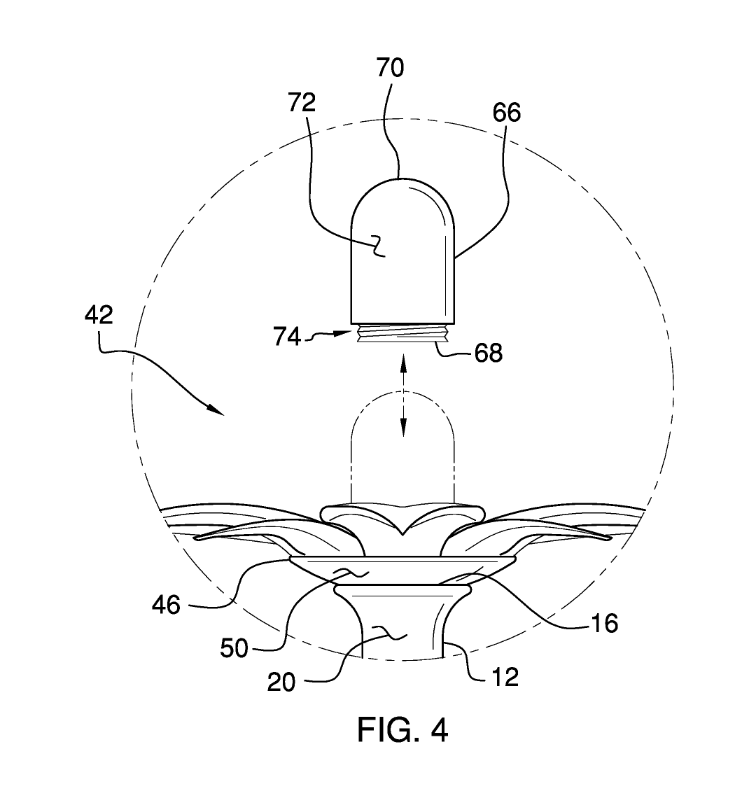

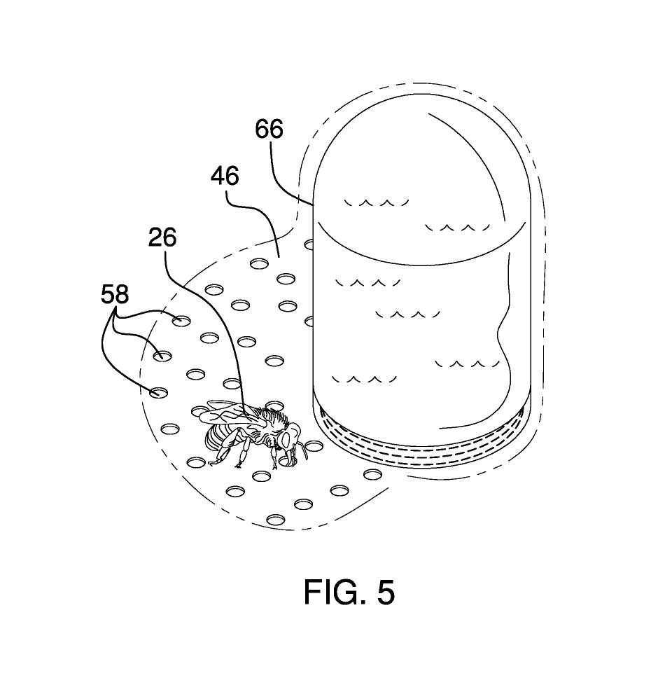

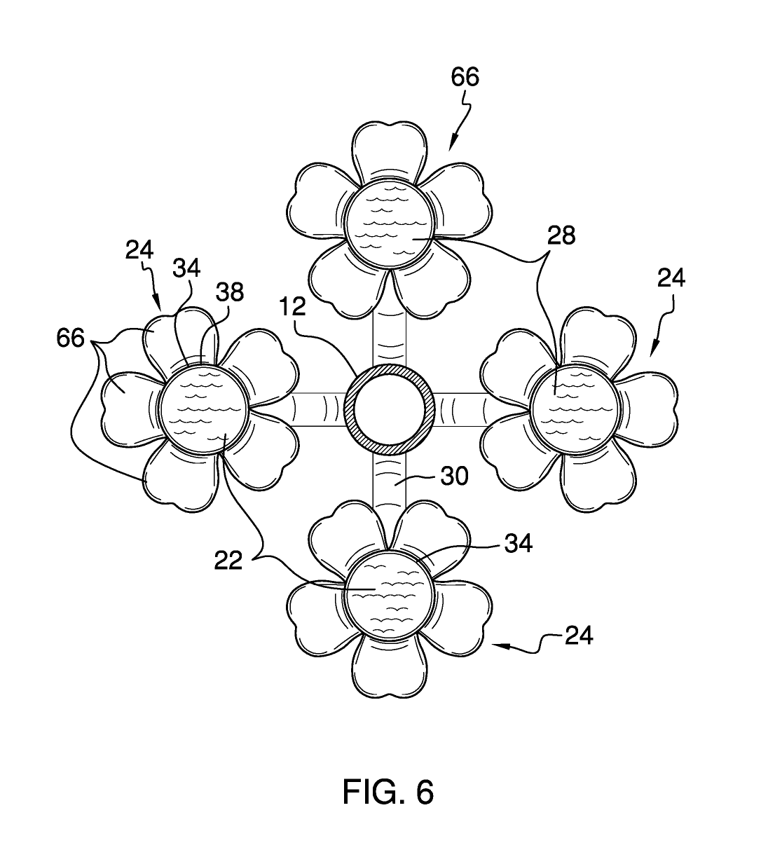

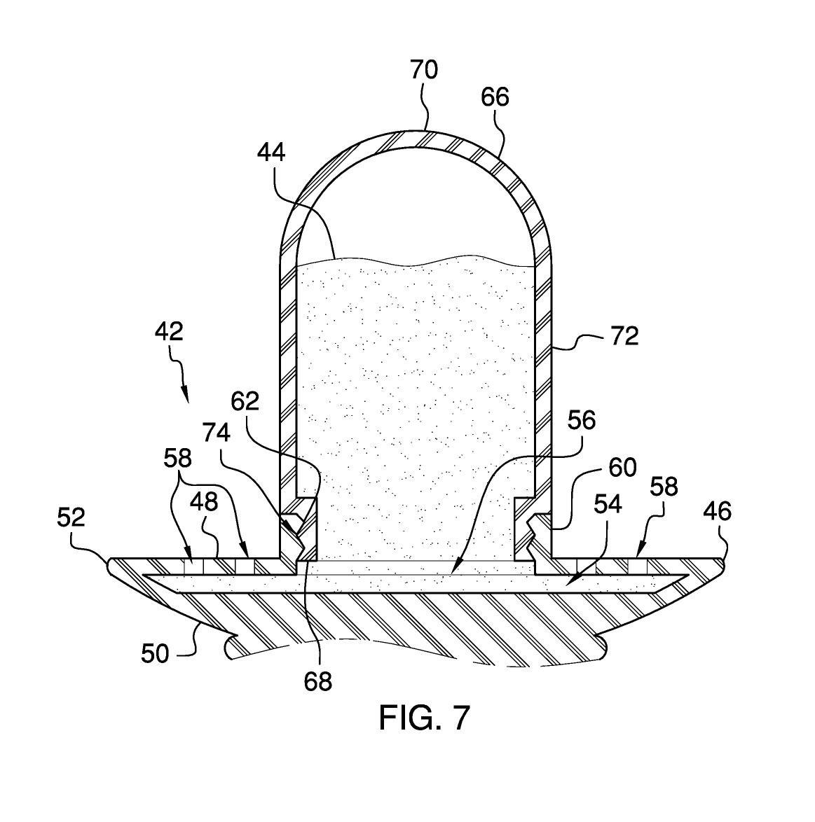

With reference now to the drawings, and in particular to FIGS. 1 through 7 thereof, a new feeding device embodying the principles and concepts of an embodiment of the disclosure and generally designated by the reference numeral 10 will be described.

As best illustrated in FIGS. 1 through 7, the insect feeding assembly 10 generally comprises a pedestal 12 that is selectively positioned on a support surface 14 such as ground or the like. The pedestal 12 has a first end 16, a second end 18 and an outer surface 20 extending therebetween. The outer surface 20 of the pedestal 12 flares outwardly toward the first end 16 to define a foot 22 for retaining the pedestal 12 in an upright position. A plurality of watering units 24 is provided and each of the watering units 24 is coupled to the pedestal 12. Each of the watering units 24 is mounted by an insect 26 and each of the watering units 24 contains water 28 for drinking by the insect 26. The insect 26 may be a pollinating insect 26 such as a honey bee, a butterfly and any other pollinating animal.

Each of the watering units 24 comprises a stem 30 that is coupled to and extends laterally away from the outer surface 20 of the pedestal 12. The stem 30 has a distal end 32 with respect to the outer surface 20 and the stem 30 curves upwardly between the pedestal 12 and the distal end 32. Thus, the distal end 32 is directed toward the second end 18 of the pedestal 12. Each watering unit 24 includes a dish 34 that has a bottom surface 36 and a perimeter edge 38. The bottom surface 36 is coupled to the distal end 32 of the stem 30 such that the dish 34 may be mounted by the insect 26 and the water 28 is selectively poured into the dish 34.

Each of the watering units 24 includes a plurality of first petals 40 and each of the first petals 40 is coupled to and extends laterally away from the perimeter edge 38 of the dish 34. The first petals 40 are distributed around an entire circumference of the dish 34. Additionally, a perimeter edge corresponding to each of the first petals 40 is contoured such that each of the first petals 40 resembles a flower petal. Thus, the first petals 40 present the ornamental appearance of a flower thereby attracting the insects 26 to the dish 34.

A feeder 42 is coupled to the pedestal 12 and the feeder 42 is selectively mounted by the insect 26. The feeder 42 contains a fluid food 44, such as nectar or the like, thereby facilitating the insect 26 to consume the fluid food 44. The pedestal 12 is positioned in a high traffic area with respect to the insects, such as a flower garden or the like. Thus, the insects 26 may rest on the feeder 42 and the watering units 24 during pollination. Additionally, the insects 26 may feed on the fluid food 44 and drink the water 28 thereby increasing the insect's 26 ability to successfully return home after pollinating.

The feeder 42 comprises a plate 46 that has a top surface 48, a bottom surface 50 and an outer edge 52 extending therebetween. The bottom surface 50 of the plate 46 is coupled to the second end 18 of the pedestal 12 and the plate 46 has a chamber 54 positioned between the top surface 48 and the bottom surface 50. The top surface 48 has a first aperture 56 extending into the chamber 54 and the first aperture 56 is centrally positioned on the top surface 48. The top surface 48 has a plurality of second apertures 58 each extending into the chamber 54. Moreover, the second apertures 58 are spaced apart from each other and are distributed around the first aperture 56.

A receiver 60 extends upwardly from the top surface 48 of the plate 46 and the receiver 60 surrounds the first aperture 56. The receiver 60 has an inwardly facing surface 62 and the inwardly facing surface 62 is threaded. A plurality of second petals 64 is provided and each of the second petals 64 is coupled to and extends laterally away from the outer edge 52 of the plate 46. The second petals 64 are distributed around an entire circumference of the plate 46. A perimeter edge corresponding to each of the second petals 64 is contoured such that each of the second petals 64 resembles a flower petal. Thus, the second petals 64 attract the insects 26 to the plate 46.

The feeder 42 includes a container 66 that has a first end 68, a second end 70 and an outside surface 72 extending therebetween. The container 66 is hollow and the container 66 contains the fluid food 44. The first end 68 of the container 66 is open to release the fluid food 44 from the container 66. Additionally, the outside surface 72 has an inset portion 74 extending from the first end 68 of the container 66 toward the second end 70 of the container 66. The inset portion 74 threadably engages the inwardly facing surface 62 of the receiver 60 such that the container 66 is inverted and releasably coupled to the receiver 60. In this way the fluid food 44 is gravity fed through the first aperture 56 and into the chamber 54 in the plate 46 thereby facilitating the insects 26 to consume the fluid food 44 through the second apertures 58.

In use, the pedestal 12 is placed outdoors in a high traffic area with respect to the insects 26, such as spot in yard that is adjacent to a flower garden or the like. Each of the watering units 24 is filled with water 28 and the container 66 is filled with the fluid food 44. The container 66 is coupled to the receiver 60 thereby facilitating the fluid food 44 to fill the chamber 54. Thus, the insects 26 may consume the fluid food 44 through the second apertures 58 in the plate 46. The watering units 24 and the feeder 42 provide a resting point for the insects 26 when the insects 26 are journeying from a pollen source to the insect's 26 home. In this way the insect's 26 chances of successfully returning home are increased by allowing the insect 26 to rest, drink and eat.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An insect feeding assembly being configured to attract and feed pollinating insects, said assembly comprising:
a pedestal being configured to be positioned on a support surface;
a plurality of watering units, each of said watering units being coupled to said pedestal wherein each of said watering units is configured to be mounted by an insect, each of said watering units being configured to contain water for drinking by the insect; and
a feeder being coupled to said pedestal wherein said feeder is configured to be mounted by an insect, said feeder being configured to contain a fluid food thereby facilitating the insect to consume the fluid food, said pedestal being configured to be positioned in a high traffic area with respect to the insects thereby facilitating the insects to rest on said feeder and said watering units during pollination.

2. The assembly according to claim 1, wherein said pedestal has a first end, a second end and an outer surface extending therebetween, said first end being configured to about the support surface having said pedestal being vertically oriented on the support surface.

3. The assembly according to claim 2, wherein each of said watering units comprises a stem being coupled to and extending laterally away from said outer surface of said pedestal, said stem having a distal end with respect to said outer surface, said stem curving upwardly between said pedestal and said distal end such that said distal end is directed toward said second end of said pedestal.

4. The assembly according to claim 3, further comprising a dish having a bottom surface and a perimeter edge, said bottom surface being coupled to said distal end of said stem wherein said dish is configured to be mounted by the insect, said dish being configured to contain the water.

5. The assembly according to claim 4, further comprising a plurality of first petals, each of said first petals being coupled to and extending laterally away from said perimeter edge of said dish, said first petals being distributed around an entire circumference of said dish wherein said first petals are configured to have the ornamental appearance of a flower thereby attracting the insects to said dish.

6. The assembly according to claim 1, wherein said feeder comprises a plate having a top surface, a bottom surface and an outer edge extending therebetween, said bottom surface being coupled to said second end of said pedestal.

7. The assembly according to claim 6, wherein said plate has a chamber being positioned between said top surface and said bottom surface.

8. The assembly according to claim 7, wherein said top surface has a first aperture extending into said chamber, said first aperture being centrally positioned on said top surface.

9. The assembly according to claim 8, wherein said top surface has a plurality of second apertures each extending into said chamber, said second apertures being spaced apart from each other and being distributed around said first aperture.

10. The assembly according to claim 9, further comprising a receiver extending upwardly from said top surface of said plate, said receiver surrounding said first aperture, said receiver having an inwardly facing surface, said inwardly facing surface being threaded.

11. The assembly according to claim 6, further comprising a plurality of second petals, each of said second petals being coupled to and extending laterally away from said outer edge of said plate, said second petals being distributed around an entire circumference of said plate wherein said second petals are configured to have the ornamental appearance of a flower thereby attracting the insects to said plate.

12. The assembly according to claim 10, further comprising a container having a first end, a second end and an outside surface extending therebetween, said container being hollow wherein said container is configured to contain the fluid food, said first end being open wherein said first end is configured to release the fluid food from said container.

13. The assembly according to claim 12, wherein said outside surface has an inset portion extending from said first end toward said second end, said inset portion threadably engaging said inwardly facing surface of said receiver wherein said first aperture in said plate is configured to direct the fluid food into said chamber in said plate thereby facilitating the insects to consume the fluid food through said second apertures.

14. An insect feeding assembly being configured to attract and feed pollinating insects, said assembly comprising:
a pedestal being configured to be positioned on a support surface, said pedestal having a first end, a second end and an outer surface extending therebetween, said first end being configured to about the support surface having said pedestal being vertically oriented on the support surface;
a plurality of watering units, each of said watering units being coupled to said pedestal wherein each of said watering units is configured to be mounted by an insect, each of said watering units being configured to contain water for drinking by the insect, each of said watering units comprising:
a stem being coupled to and extending laterally away from said outer surface of said pedestal, said stem having a distal end with respect to said outer surface, said stem curving upwardly between said pedestal and said distal end such that said distal end is directed toward said second end of said pedestal;
a dish having a bottom surface and a perimeter edge, said bottom surface being coupled to said distal end of said stem wherein said dish is configured to be mounted by the insect, said dish being configured to contain the water; and
a plurality of first petals, each of said first petals being coupled to and extending laterally away from said perimeter edge of said dish, said first petals being distributed around an entire circumference of said dish wherein said first petals are configured to have the ornamental appearance of a flower thereby attracting the insects to said dish; and
a feeder being coupled to said pedestal wherein said feeder is configured to be mounted by an insect, said feeder being configured to contain a fluid food thereby facilitating the insect to consume the fluid food, said pedestal being configured to be positioned in a high traffic area with respect to the insects thereby facilitating the insects to rest on said feeder and said watering units during pollination, said feeder comprising:
a plate having a top surface, a bottom surface and an outer edge extending therebetween, said bottom surface being coupled to said second end of said pedestal, said plate having a chamber being positioned between said top surface and said bottom surface, said top surface having a first aperture extending into said chamber, said first aperture being centrally positioned on said top surface, said top surface having a plurality of second apertures each extending into said chamber, said second apertures being spaced apart from each other and being distributed around said first aperture;
a receiver extending upwardly from said top surface of said plate, said receiver surrounding said first aperture, said receiver having an inwardly facing surface, said inwardly facing surface being threaded;
a plurality of second petals, each of said second petals being coupled to and extending laterally away from said outer edge of said plate, said second petals being distributed around an entire circumference of said plate wherein said second petals are configured to have the ornamental appearance of a flower thereby attracting the insects to said plate; and
a container having a first end, a second end and an outside surface extending therebetween, said container being hollow wherein said container is configured to contain the fluid food, said first end being open wherein said first end is configured to release the fluid food from said container, said outside surface having an inset portion extending from said first end toward said second end, said inset portion threadably engaging said inwardly facing surface of said receiver wherein said first aperture in said plate is configured to direct the fluid food into said chamber in said plate thereby facilitating the insects to consume the fluid food through said second apertures.
